(19) United States
(12) Patent Application Publication
(10) Pub. No.: US 2010/0287878 A1
(43) Pub. Date: Nov. 18, 2010

(54) STRUCTURAL COMPOSITE HYBRID BEAM(SCHB) CONSISTING OF COLD-FORMED STEEL AND CAST-IN-PLACE CONCRETE HAVING ATTACHED FIRE-RESISTANT COATING MATERIAL AND CONSTRUCTING METHOD OF THE SCHB

(75) Inventors: Chang Nam LEE, Seoul (KR); Jun Suk LEE, Seoul (KR); Woo Chul KIM, Seoul (KR)

Correspondence Address: Jason Y. Pahng and Associates, LLC, 12178 Bridgend Run, Fairfax, VA, 22030, US

(73) Assignees: SENVEX CO.,LTD., Seoul (KR); SUNG HYUN CHEMICALS CO., LTD., Seoul (KR)

(21) Appl. No.: 12/723,699

(22) Filed: Mar. 15, 2010

(30) Foreign Application Priority Data
May 15, 2009 (KR) 10-2009-0042702

(51) Int. Cl. E04C 3/293; E04C 3/29; E04B 1/94; B32B 37/02

(52) U.S. Cl. 52/834; 52/831; 52/847; 52/854; 156/280

(57) ABSTRACT

A structural composite hybrid beam having an attached fire-resistant coating material, the structural composite hybrid beam including: a cold-formed steel plate beam, which is formed into a form shape having a space where concrete is placed; a concrete slab installed on the cold-formed steel plate beam and that is integrally connected to the concrete; and a flow preventing member protruding from a pair of side plates of the cold-formed steel plate beam, and preventing the fire-resistant coating material sprayed on each of the pair of side plates from flowing down so that the fire-resistant coating material is firmly attached to the each of the pair of side plates. A thickness of the fire-resistant coating material is reduced as the concrete inside the structural composite hybrid beam absorbs heat, and thus construction expenses are reduced. Accordingly, the structural composite hybrid beam has excellent fire-resistant performance unlike a general steel-frame beam.

### CROSS-REFERENCE TO RELATED PATENT APPLICATION

This application claims the benefit of Korean Patent Application No. 10-2009-0042702, filed on May 15, 2009, in the Korean Intellectual Property Office, the disclosure of which is incorporated herein in its entirety by reference.

### BACKGROUND OF THE INVENTION

1. Field of the Invention

The present invention relates to a structural composite hybrid beam and more particularly, to a structural composite hybrid beam consisting of cold-formed steel and cast-in-place concrete having at least one flow preventing member fixed to each of side plates of a cold-formed steel plate beam, and the constructing method of the structural composite hybrid beam, wherein the at least one flow preventing member prevents a fire resistant coating material sprayed on the each of side plates from flowing down and attaches the fire resistant material firmly to the each of side plates while preventing a gap between the fire resistant coating material and each of the side plates, thereby improving the coating performance and fire-resistant performance of the fire resistant coating material.

2. Description of the Related Art

Generally, a suitable structural type of a building is selected in consideration of the use, functions, safety against an external force, and economical efficiency of the building.

The structural types include various structural systems, such as a traditional wooden structure, a reinforced concrete structure, and a steel-frame structure. Here, the most commonly used structural types are a reinforced concrete structure, a steel-frame structure, and a hybrid beam structure having merits of both a reinforced concrete structure and a steel-frame structure.

A reinforced concrete structure is formed by integrating re-bars and concrete in such a way that weak points thereof are complemented. In other words, in order to reinforce the concrete which is more vulnerable to tensile stress than compressive stress, re-bars are disposed where the tensile stress acts on. Accordingly, the reinforced concrete structure can bear a heavy load.

However, the reinforced concrete structure is heavy and easily cracks. Also, the durability of the reinforced concrete structure decreases due to neutralization, and construction expenses and construction term increase due to installation and dismantlement of a form. Accordingly, a steel-frame structure is preferably used for a large-scale important building.

The steel-frame structure has excellent structural efficiency, and has a remarkably reduced construction term since a steel-frame pre-manufactured in a factory is used. However, material costs are high compared to other structures, costs of a fire-resistant coating are high, and a floor height increases if the depth of a beam is increased so as to reduce vibration and deflection. Accordingly, hybrid beams that use a reinforced concrete slab, which is used as a bottom plate, as a part of a beam are being developed. In this regard, a structural composite hybrid beam is a recently developed building structure used to complement weak points of both the reinforced concrete structure and the steel-frame structure, wherein concrete is placed in a space of a cold-formed steel plate beam having an open-top form shape.

Since concrete is placed in an internal space of the cold-formed steel plate beam having an open-top form shape, the cold-formed steel plate beam operating as a form also operates as a steel-frame structure, and the concrete in the internal space and an upper slab operate as a reinforced concrete structure.

In other words, in the structural composite hybrid beam consisting of cold-formed steel and cast-in-place concrete, a form does not need to be separately dismantled, and a depth of the structural composite hybrid beam is decreased as the cold-formed steel plate beam functions with the upper slab so as to operate as a hybrid beam. Accordingly, a floor height can be reduced, and thus compared to a steel-frame structure having the same height, for example, eleven floors can be made by using the structural composite hybrid beam structure, whereas only ten floors are made by using the steel-frame structure.

Meanwhile, if the structural composite hybrid beam is heated for a long time due to fire, the load carrying capacity of a structural steel may deteriorate. Accordingly, in order to increase the fire-resistance performance, the exposed bottom surface and side of structural composite hybrid beam may be sprayed with a fire-resistant coating material mixed with water.

Accordingly, since the structural steel is exposed to the outside from the bottom surface and the side of the structural composite hybrid beam, a fire-resistant coating material mixed with water is sprayed in a predetermined thickness as a layer on the bottom surface and side of the structural composite hybrid beam. Examples of the fire-resistant coating material include rock wool, vermiculite, perlite, and plaster.

As well known to one of ordinary skill in the art, the Korean Evaluation

Standard for Fire-Resistant Performance by the Ministry of Land, Transport and Marine Affairs is set to be: average temperature of 538° C. or lower; and maximum temperature of 649° C. or lower. If a fire-resistant coating material does not comply with the above standard, the use of the fire-resistant coating material is not appropriate.

However, when the bottom surface and side of the structural composite hybrid beam are sprayed with a fire-resistant coating material, the fire-resistant coating material sprayed on side plates of the structural composite hybrid beam flows down due to its weight during a curing period, because the side plates extend vertically and the joint of side plates and bottom plate are rounded. Accordingly, the fire-resistant coating material may be detached from the side plate due to a low adhesive force, and thus the fire-resistant performance of the structural composite hybrid beam may deteriorate.

Also, according to a conventional constructing method of a fire-resistant coating material, the fire-resistant coating material flows down and a gap occurs between a side plate and the fire-resistant coating material, since characteristics of a mixture of the fire-resistant coating material and water, ejecting pressure of the fire-resistant coating material sprayed on a coated surface of the structural composite hybrid beam, and a distance between an ejecting nozzle and the coated surface are not appropriate.

### SUMMARY OF THE INVENTION

The present invention provides a structural composite hybrid beam consisting of cold-formed steel and cast-in-place concrete having an attached fire-resistant coating material, wherein the fire-resistant coating material is sprayed and prevented from flowing down by at least one flow preventing member fixed to each of side plates of a structural composite hybrid beam, and its coating performance and fire-resistant performance are improved as the fire-resistant coating material and the side plates are firmly attached to each other without a gap.

The present invention also provides a constructing method of a structural composite hybrid beam having an attached fire-resistant coating material, wherein the fire-resistant coating material is prevented from flowing down and a gap between a side plate and the fire-resistant coating material is prevented from occurring, by uniformly maintaining a mixing ratio of the fire-resistant coating material and water and optimizing ejecting pressure of the fire-resistant coating material while maintaining a distance between an ejecting nozzle and a coated surface of a structural composite hybrid beam constant.

The present invention also provides a structural composite hybrid beam, wherein a thickness of a fire-resistant coating is reduced according to heat-absorption by internal concrete and accordingly construction expenses are reduced.

According to an aspect of the present invention, there is provided a structural composite hybrid beam including an attached fire-resistant coating material, the structural composite hybrid beam including: a cold-formed steel plate beam which is formed into a form shape having a space where concrete is placed. a concrete slab installed on the cold-formed steel plate beam and that is integrally connected to the concrete; and at least one flow preventing member protruding from each of a pair of side plates of the cold-formed steel plate beam, and preventing the fire-resistant coating material sprayed on the each of the pair of side plates from flowing down so that the fire-resistant coating material is firmly attached to the each of the pair of side plates.

The at least one flow preventing member may include: an attach plate attached to the each of the pair of side plates extending in a vertical direction on the cold-formed steel plate beam; and a support plate extending in a horizontal direction from an upper or lower end of the attach plate so as to prevent the sprayed fire-resistant coating material from flowing down.

The at least one flow preventing member may include: an attach plate attached to the side plate extending in a vertical direction on the cold-formed steel plate beam; and a support plate extending in a horizontal direction from an upper end of the attach plate so as to prevent the sprayed fire-resistant coating material from flowing down, wherein the support plate may include: a pair of holding protrusions for preventing the fire-resistant coating material from flowing down from either end of the at least one flow preventing member; and at least one reinforcing protrusion for reinforcing the strength of the attach plate and preventing the fire-resistant coating material from flowing by protruding between the pair of holding protrusions.

The at least one flow preventing member may include: an attach plate attached to the side plate extending in a vertical direction on the cold-formed steel plate beam; and a support plate extending in a horizontal direction from an upper end of the attach plate so as to prevent the sprayed fire-resistant coating material from flowing down.

The at least one flow preventing member may further include a bonding part for adhering the attach plate to a side of the side plate, wherein the bonding part may be at least one selected from the group consisting of a welding agent, an adhesive agent, and an epoxy adhesive agent.

The at least one flow preventing member may further include a fastener for combining the attach plate to the each of the pair of side plates.

A thickness of the fire-resistant coating material sprayed on the each of the pair of side plates may be from about 8 mm to about 12 mm when the duration of a fire is about 1 hour, from about 10 mm to about 18 mm when the duration of a fire is about 2 hours, and from about 12 mm to about 25 mm when the duration of a fire is about 3 hours.

A length of the fire-resistant coating material sprayed outwardly from an upper end of the at least one side plate may be from about 50 mm to about 150 mm.

The structural composite hybrid beam may include: a bottom plate formed by horizontally installing a steel plate so as to form a bottom surface of the structural composite hybrid beam; the pair of side plates extending in a vertical direction from each end of the bottom plate and forming two sides of the structural composite hybrid beam; an upper flange horizontally extending from an upper end of each of the pair of side plates to an internal side or external side; and a fixing protrusion extending from the center of the bottom plate toward the upper flange, with upper portions extending in opposite directions.

The structural composite hybrid beam may further include a shear connector for enhancing an integral connection between the concrete slab and the concrete.

According to another aspect of the present invention, there is provided a constructing method of a structural composite hybrid beam including an attached fire-resistant coating material, the method including: forming a steel plate into a cold-formed steel plate beam having a form shape including a pair of side plates, a bottom plate, and upper flanges; adhering at least one flow preventing member comprising an attach plate and a support plate to a side of the side plate; mixing and stirring the fire-resistant coating material with water in a ratio of from 1:1 to 1:1.3 sufficiently for about 3 to about 5 minutes; spraying the stirred fire-resistant coating material by using an ejecting nozzle, while maintaining a distance between a coated surface of the cold-formed steel plate beam and the ejecting nozzle to be from about 30 cm to about 60 cm, the pressure of a compressor to be from about 2.5 kg/cm² to about 5 kg/cm², and an air amount to be about 0.4 m³/min to about 0.5 m³/min; and curing the sprayed fire-resistant coating material.

According to another aspect of the present invention, there is provided a constructing method of a structural composite hybrid beam including an attached fire-resistant coating material, the method including: forming a steel plate into a cold-formed steel plate beam having a form shape including a pair of side plates, a bottom plate, and upper flanges; adhering at least one flow preventing member comprising an attach plate and a support plate to a side of the side plate; mixing and stirring the fire-resistant coating material with water in a ratio of from 1:1 to 1:1.3 sufficiently for about 3 to about 5 minutes; cleaning a coated surface of the cold-formed steel plate beam to be sprayed on so as to remove foreign substances or impurities from the coated surface; spraying the stirred fire-resistant coating material by using an ejecting nozzle, while maintaining a distance between the coated surface of the cold-formed steel plate beam and the ejecting nozzle to be from about 30 cm to about 60 cm, the pressure of a compressor to be from about 2.5 kg/cm² to about 5 kg/cm², and an air amount to be about 0.4 m³/min to about 0.5 m³/min; and curing the sprayed fire-resistant coating material.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a structural composite hybrid beam having at least one flow preventing member, according to an embodiment of the present invention;

FIG. 2 is an enlarged exploded perspective view of the structural composite hybrid beam of FIG. 1;

FIG. 3 is a partial enlarged side view of FIG. 2;

FIG. 4 is a partial widthwise cross-sectional view of the structural composite hybrid beam of FIG. 1;

FIG. 5 is a partial widthwise cross-section view of a sprayed state of the structural composite hybrid beam, wherein a flow preventing member is fixed to the structural composite hybrid beam with a fastener;

FIG. 6 is a perspective view of a flow preventing member according to another embodiment of the present invention;

FIG. 7 is a partial widthwise cross-sectional view of a sprayed state of the structural composite hybrid beam having a flow preventing member, according to another embodiment of the present invention;

FIG. 8 is a cross-sectional view of a sprayed state of the structural composite hybrid beam having an upper flange horizontally extending from an upper end of a side plate to an external side, according to an embodiment of the present invention;

FIG. 9 is a flowchart illustrating a constructing method of a structural composite hybrid beam having an attached fire-resistant coating material, according to an embodiment of the present invention; and

FIG. 10 is a graph showing a test result of spraying 20 mm of a fire-resistant coating material on the structural composite hybrid beam of FIG. 1 by the Korea Institute of Construction Technology (KICT).

### DETAILED DESCRIPTION OF THE INVENTION

Hereinafter, the present invention will be described more fully with reference to the accompanying drawings, in which exemplary embodiments of the invention are shown.

In the drawings, the thicknesses of lines or sizes of elements may be exaggerated for clarity. Also, terms used hereinafter are defined considering functions in the present invention, and thus may differ according to intensions or customs of a user or an operator. Accordingly, the terms may be defined based on contents of the present specification.

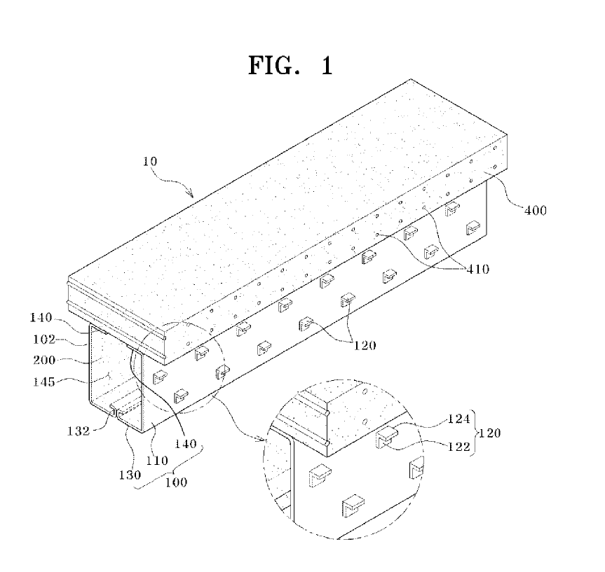

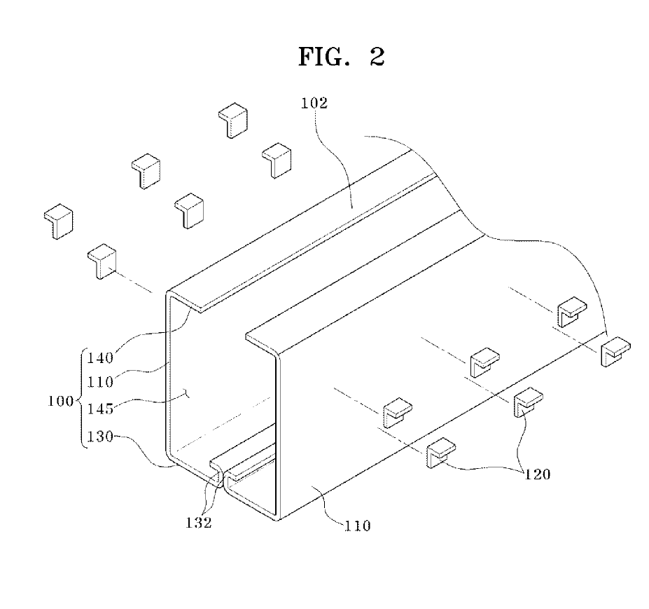

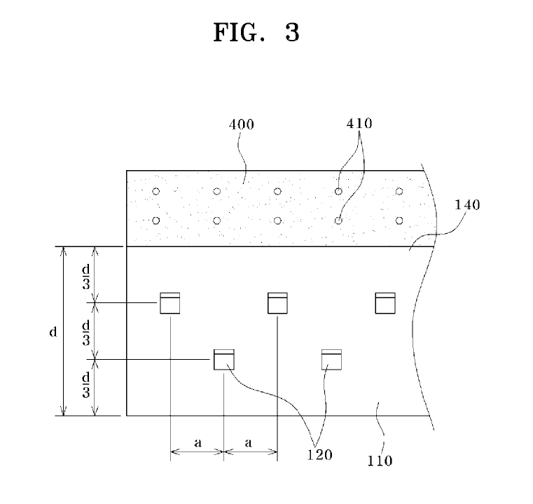

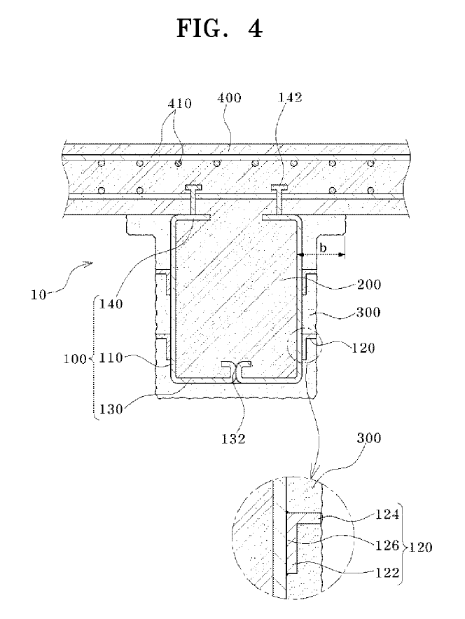

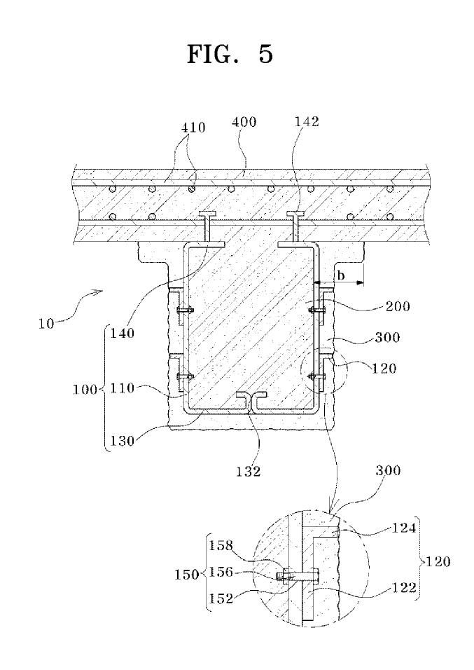

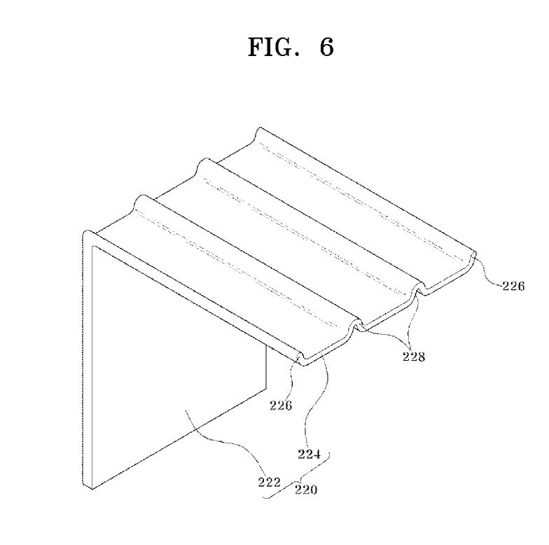

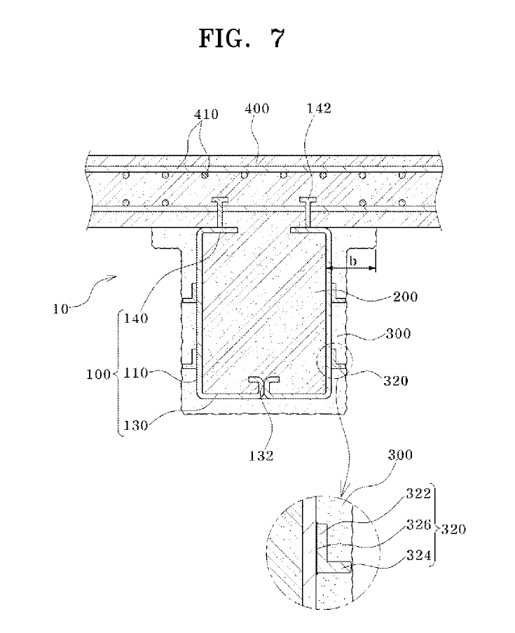

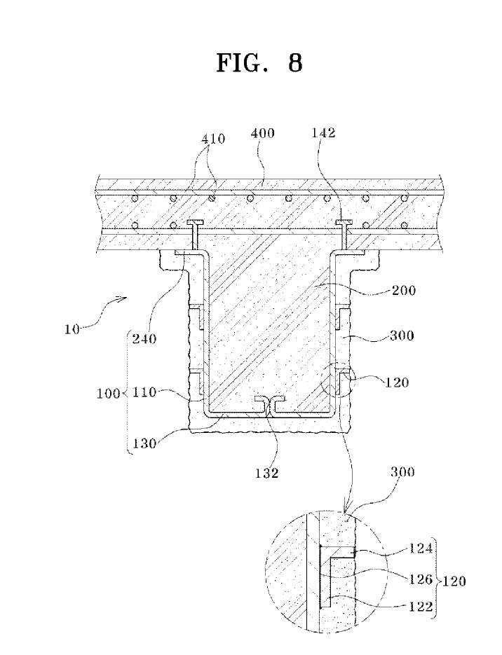

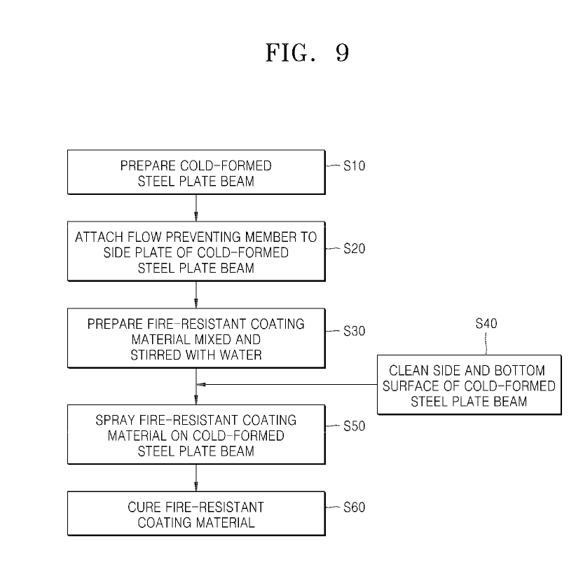

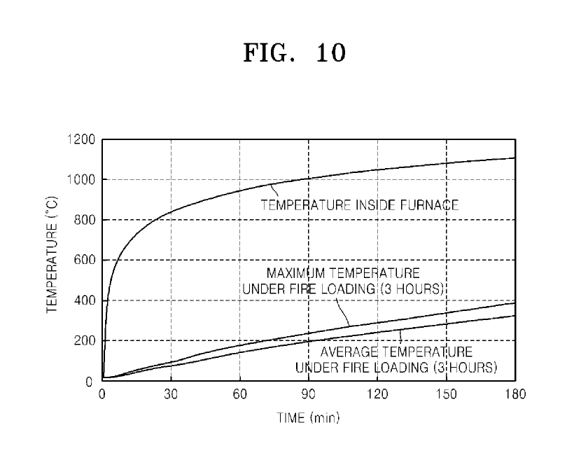

FIG. 1 is a perspective view of a structural composite hybrid beam 10 having at least one flow preventing member 120, according to an embodiment of the present invention, FIG. 2 is a enlarged perspective view of a part of the structural composite hybrid beam 10 of FIG. 1, FIG. 3 is a partial enlarged side view of FIG. 2, FIG. 4 is a partial widthwise cross-sectional view of the structural composite hybrid beam 10 of FIG. 1, FIG. 5 is a partial widthwise cross-sectional view of a sprayed state of the structural composite hybrid beam 10, wherein the flow preventing member 120 is fixed to the structural composite hybrid beam 10 with a fastener 150, FIG. 6 is a perspective view of a flow preventing member 220 according to an embodiment of the present invention, FIG. 7 is a partial widthwise cross-sectional view of a sprayed state of the structural composite hybrid beam 10 having a flow preventing member 320, according to an embodiment of the present invention, FIG. 8 is a partial widthwise cross-sectional view of a sprayed state of the structural composite hybrid beam 10 having an upper flange 240 horizontally extending from an upper end of a side plate 110 to an external side, according to an embodiment of the present invention, FIG. 9 is a flowchart illustrating a constructing method of a structural composite hybrid beam having an attached fire-resistant coating material, according to an embodiment of the present invention, and FIG. 10 is a graph showing a test result of spraying 20 mm of a fire-resistant coating material on the structural composite hybrid beam 10 of FIG. 1 by the Korea Institute of Construction Technology (KICT).

Referring to FIGS. 1 through 8, the structural composite hybrid beam 10 according to an embodiment of the present invention includes a cold-formed steel plate beam 100 formed in a form shape having an inner space 145 in which concrete 200 is placed; a concrete slab 400 disposed on the cold-formed steel plate beam 100 and that is integrally connected to the concrete 200; and the flow preventing member 120, 220, or 320 that protrudes from the side plate 110 of the cold-formed steel plate beam 100 and firmly attaches a fire-resistant coating material 300 to a side of the cold-formed steel plate beam 100 by preventing the fire-resistant coating material 300 sprayed on the side plate 110 from flowing down.

The concrete slab 400 may have re-bars 410 for reinforcement.

The flow preventing member 120, 220, or 320 may be formed of a zinc galvanized steel plate, but is not limited thereto. In other words, the flow preventing member 120, 220, or 320 may be formed of another steel plate or plastic.

As shown in FIGS. 2 through 4, the flow preventing member 120 according to an embodiment of the present invention includes an attach plate 122 that is attachable to the side plate 110 extending in a vertical direction on the side of the cold-formed steel plate beam 100; and a support plate 124 that extends in a horizontal direction from an upper end of the attach plate 122 so as to prevent the sprayed fire-resistant coating material 300 from flowing down. In other words, the flow preventing member 120 has a ┌-shape.

The flow preventing member 120 may further include a bonding part 126 for bonding the attach plate 122 to the side of the side plate 110 of the cold-formed steel plate beam 100. Here, the bonding part 126 may be at least one selected from the group consisting of a welding agent, an adhesive agent, and an epoxy adhesive agent.

The flow preventing members 120, 220, or 320 may be disposed in a zigzag manner on locations corresponding to ⅓ and ⅔ of the depth d of the side plate 110.

A horizontal distance between the adjacent flow preventing members 120, 220, or 320 in the zigzag pattern may be about 60 cm, with an error tolerance of about 10 cm.

A thickness of the fire-resistant coating material 300 sprayed on the side plate 110 of the cold-formed steel plate beam 100 may be from about 8 mm to about 12 mm when the duration of a fire is about 1 hour, from about 10 mm to about 18 mm when the duration of a fire is about 2 hours, and from about 12 mm to about 25 mm when the duration of a fire is about 3 hours.

Also, a length of the fire-resisting coating material 300 sprayed outwardly from an upper end of the side plate may be from 50 to 150 mm, in detail, about 100 mm.

Referring to FIG. 6, a flow preventing member 220 according to an embodiment of the present invention includes: an attach plate 222 that is attachable to the side plate 110 extending in a vertical direction on the side of the cold-formed steel plate beam 100; and a support plate 224 that extends in a horizontal direction from an upper end of the attach plate 222 so as to prevent the sprayed fire-resistant coating material 300 from flowing down.

Here, the support plate 224 includes: a pair of holding protrusions 226 that prevent the fire-resistant coating material 300 from flowing down from either ends of the flow preventing member 220; and at least one reinforcing protrusion 228 that protrudes between the pair of holding protrusions 226 so as to reinforce the strength of the attach plate 222 and prevent the fire-resistant coating material 300 from flowing.

The holding protrusion 226 and the reinforcing protrusion 228 may be formed through pressurization by using a press, but are not limited thereto.

The flow preventing member 220 may further include a bonding part (not shown) so as to attach the attach plate 222 to the side plate 110. The bonding part may be at least one selected from the group consisting of a welding agent, an adhesive agent, and an epoxy adhesive agent.

Referring to FIG. 7, the flow preventing member 320 according to an embodiment of the present invention may include: an attach plate 322 that is attachable to the side plate 110 extending in a vertical direction on the side of the cold-formed steel plate beam 100; and a support plate 324 that is bent in a horizontal direction from a lower end of the attach plate 322 so as to prevent the sprayed fire-resistant coating material 300 from flowing down. In other words, the flow preventing member 320 has an L shape.

The flow prevent member 320 may further include a bonding part 326 for attaching the attach plate 322 to the side of the side plate 110. Here, the bonding part 326 may be at least one selected from the group consisting of a welding agent, an adhesive agent, and an epoxy adhesive agent.

Alternatively, as shown in FIG. 5, the flow preventing members 120, 220, and 320 according to the embodiments of the present invention may further include the fastener 150 for combining the attach plates 122, 222, and 322 thereof to the side of the side plate 110, instead of the bonding parts 126 and 326.

The fastener 150 may include hole 152 formed in the side plate, and a bolt 156 and a nut 158 for fixing the attach plate 122, 222, or 322 to the side plate 110.

The cold-formed steel plate beam 100 according to the above embodiments of the present invention includes: a bottom plate 130 formed parallel to the steel plate 102 as a bottom surface of the cold-formed steel plate beam 100; a pair of side plates 110 extending in a vertical direction from each end of the bottom plate 130 and forming two sides of the cold-formed steel plate beam 100; an upper flange 140 or 240 horizontally extending from the upper end of the side plates 110 respectively to an internal side or external side; and a fixing protrusion 132 protruding from the center of the bottom plate 130 toward the steel plate 102, with upper portions bent to form a “Y” shape or a “T” shape. The cold-formed steel plate beam 100 may further include a shear connector 142 for enhancing an integral connection between the concrete slab 400 and the concrete 200.

A deck plate (not shown) may be further included on each end of the upper flange 140 so as to support a bottom surface of the concrete slab 400.

Meanwhile, the structural composite hybrid beam 10 of FIG. 8 includes the upper flange 240 that is bent toward an external side. The structural composite hybrid beam 10 of FIGS. 1 through 4 and the structural composite hybrid beam 10 of FIG. 8 are identical except in that the upper flange 140 of the structural composite hybrid beam 10 of FIGS. 1 through 4 is bent to an internal side and the upper flange 240 of the structural composite hybrid beam 10 FIG. 8 is bent to an external side, and thus detailed descriptions about the structural composite hybrid beam 10 of FIG. 8 will be omitted herein.

Hereinafter, a constructing method of the structural composite hybrid beam 10 having an attached fire-resistant coating material, according to an embodiment of the present invention will be described.

FIG. 9 is a flowchart illustrating a constructing method of a structural composite hybrid beam having an attached fire-resistant coating material, according to an embodiment of the present invention. The method will be described with reference to FIGS. 1 through 8.

As shown in FIGS. 1 through 8, the cold-formed steel plate beam 100 having a form shape is formed by forming the steel plate 102 to have the side plates 110, the bottom plate 130, and the upper flange 140, in operation S10.

Then, the flow preventing member 120, 220, or 320 having the attach plate 122, 222, or 322 and the support plate 124, 224, or 324 is prepared on the side of the side plate 110, and the attach plate 122, 222, or 322 is attached to the side plate 110, in operation S20.

Here, it is checked whether the attach plate 122, 222, or 322 is firmly attached to the side plate 110 with a welding agent, an epoxy adhesive agent, or the like.

When the attach plate 122, 222, or 322 is attached to the side plate 110 with the fastener 150, the hole 152 of the side plate 110 corresponds to a hole (not shown) of the attach plate 122, 222, or 322, then the bolt 156 is inserted through the both the hole 152 and the hole of the attached plate 122, 222, or 322 and fastened with the nut 158.

In operation S30, the fire-resistant coating material 300 is mixed with water in a ratio of from 1:1 to 1:1.3, and is sufficiently stirred for about 3 to about 5 minutes.

Here, the fire-resistant coating material 300 may be used within 30 minutes after being mixed with water, and may be disposed of after 60 minutes.

Next, a coated surface of the cold-formed steel plate beam 100 on which the fire-resistant coating material 300 shall be sprayed is cleaned in operation S40 so as to remove foreign substances or impurities.

In operation S50, the stirred fire-resistant coating material 300 is sprayed by using an ejecting nozzle (not shown), while maintaining a distance between the coated surface of the cold-formed steel plate beam 100 and the ejecting nozzle to be from about 30 cm to about 60 cm, the pressure of a compressor (not shown) to be from about 2.5 kg/cm² to about 5 kg/cm², and an air amount to be about 0.4 m³/min to about 0.5 m³/min.

During operation S50, an ejecting angle of the nozzle may be 90° with respect to the coated surface, with an error tolerance of 30°. It is prohibited that the ejecting angle exceeds the error tolerance.

Currently, as well known to one of ordinary skill in the art, a thickness of a conventional fire-resistant coating material officially authenticated by Korea Institute of Construction Technology (KICT) is from 12 mm to 22 mm when the duration of a fire is 1 hour, from 25 mm to 33 mm when the duration of a fire is 2 hours, and from 35 mm to 44 mm when the duration of a fire is 3 hours, when an H-shape steel beam is adopted as a load carrying beam.

However according to the current embodiment of the present invention, the thickness of the sprayed fire-resistant coating material 300 is from about 8 mm to about 25 mm.

In other words, the thickness of the fire-resistant coating material 300 sprayed on the side plate 110 may be from about 8 mm to about 12 mm when the duration of a fire is 1 hour, from about 10 mm to about 18 mm when the duration of a fire is 2 hours, and from about 12 mm to about 25 mm when the duration of a fire is 3 hours. Accordingly, despite that the thickness of the fire-resistant coating material 300 is half the thickness of the conventional fire-resistant coating material, the fire-resistant coating material 300 shows excellent fire-resistant performance.

FIG. 10 is a graph showing a test result of spraying the fire-resistant coating material 300 on the structural composite hybrid beam 10 of FIG. 1. The test was carried out by the KICT. The maximum temperature for the performance evaluation standard is 649°, but the temperature of the structural composite hybrid beam 10 was increased only up to 390° C. or less, and thus the structural composite hybrid beam 10 has excellent fire-resistant performance.

As such, the fire-resistant coating material 300 shows the same or better fire-resistant performance compared to the conventional fire-resistant coating material despite of the half thickness of the fire-resistant coating material 300, because the concrete 200 filled in the inner space 145 of the cold-formed steel plate beam 100 partially absorbs heat generated outside the structural composite hybrid beam 10 due to fire.

Also, as shown in FIGS. 4, 5, and 7, the length of the fire-resistant coating material 300 sprayed outwardly from an upper end of the side plate is from about 50 mm to about 150 mm in the cold-formed steel plate beam 100 having the upper flanges 140 bent to the internal side, and thus the heat is prevented from penetrating into a gap where the concrete slab 400 and the upper flange 140 are connected to each other. Accordingly, the structural composite hybrid beam 10 has excellent fire-resistant performance.

Meanwhile, as shown in FIG. 8, the length of the fire-resistant coating material 300 sprayed outwardly from an upper end of the side plate 110 may be sufficient to cover the upper flanges 240 in the cold-formed steel plate beam 100, and thus the heat is prevented from penetrating into a gap where the concrete slab 400 and the upper flange 240 are connected to each other. Accordingly, the structural composite hybrid beam 10 has excellent fire-resistant performance.

Referring back to FIG. 9, the sprayed fire-resistant coating material 300 is cured in operation S60. If the fire-resistant coating material 300 needs to be sprayed again, the previously sprayed fire-resistant coating material 300 is cured for at least about 24 hours at temperature of at least 5° C. before being sprayed on again.

A thickness error of the cured fire-resistant coating material 300 needs to be within +1 mm or −0 mm when measured by thickness measuring gage.

An area where the fire-resistant coating material 300 peels off or cracks during construction are repaired after a standard curing period.

As described above, by using a structural composite hybrid beam having the attached fire-resistant coating material of the present invention, a flow preventing member fixed to outer surfaces of the side plates of the cold-formed steel plate beam prevents the sprayed fire-resistant coating material from flowing down, and the fire-resistant coating material and the side plate are firmly adhered to each other without a gap. Accordingly, the coating performance and fire-resistant performance of the structural composite hybrid beam is increased.

Also, the present invention provides a constructing method of the fire-resistant coating material, which prevents a gap between the side plate and the flow preventing member from occurring and the fire-resistant coating material from entering the gap as the fire-resistant coating material flows down, by uniformly maintaining a mixing ratio of the fire-resistant coating material and water and optimizing ejecting pressure while maintaining a distance between the coated surface of the structural composite hybrid beam and the ejecting nozzle constant.

In addition, the thickness of the fire-resistant coating material is reduced as concrete inside the structural composite hybrid beam absorbs heat, and thus construction expenses are reduced. Accordingly, the fire-resistant performance of the structural composite hybrid beam has excellent fire-resistant performance compared to a general steel-frame beam.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A structural composite hybrid beam comprising an attached fire-resistant coating material, the structural composite hybrid beam comprising:
a cold-formed steel plate beam which is formed into a form shape having a space where concrete is placed;
a concrete slab installed on the cold-formed steel plate beam and that is integrally connected to the concrete; and
at least one flow preventing member protruding from each of a pair of side plates of the cold-formed steel plate beam, and preventing the fire-resistant coating material sprayed on the each of the pair of side plates from flowing down so that the fire-resistant coating material is firmly attached to the each of the pair of side plates.

2. The structural composite hybrid beam of claim 1, wherein the at least one flow preventing member comprises:
an attach plate attached to the each of the pair of side plates extending in a vertical direction on the cold-formed steel plate beam; and
a support plate extending in a horizontal direction from an upper or lower end of the attach plate so as to prevent the sprayed fire-resistant coating material from flowing down.

3. The structural composite hybrid beam of claim 1, wherein the at least one flow preventing member comprises:
an attach plate attached to the side plate extending in a vertical direction on the cold-formed steel plate beam; and
a support plate extending in a horizontal direction from an upper end of the attach plate so as to prevent the sprayed fire-resistant coating material from flowing down,
wherein the support plate comprises:
a pair of holding protrusions for preventing the fire-resistant coating material from flowing down from either end of the at least one flow preventing member; and
at least one reinforcing protrusion for reinforcing the strength of the attach plate and preventing the fire-resistant coating material from flowing by protruding between the pair of holding protrusions.

4. The structural composite hybrid beam of claim 2, wherein the at least one flow preventing member further comprises a bonding part for adhering the attach plate to a side of the side plate,
wherein the bonding part is at least one selected from the group consisting of a welding agent, an adhesive agent, and an epoxy adhesive agent.

5. The structural composite hybrid beam of claim 2, wherein the at least one flow preventing member further comprises a fastener for combining the attach plate to the each of the pair of side plates.

6. The structural composite hybrid beam of claim 1, wherein a thickness of the fire-resistant coating material sprayed on the each of the pair of side plates is from about 8 mm to about 12 mm when the duration of a fire is about 1 hour, from about 10 mm to about 18 mm when the duration of a fire is about 2 hours, and from about 12 mm to about 25 mm when the duration of a fire is about 3 hours.

7. The structural composite hybrid beam of claim 1, wherein a length of the fire-resistant coating material sprayed outwardly from an upper end of the at least one side plate is from about 50 mm to about 150 mm.

8. The structural composite hybrid beam of claim 1, wherein the cold-formed steel plate beam comprises:
a bottom plate formed by horizontally installing a steel plate so as to form a bottom surface of the cold-formed steel plate beam;
the pair of side plates extending in a vertical direction from each end of the bottom plate and forming two sides of the cold-formed steel plate beam;
an upper flange horizontally extending from an upper end of each of the pair of side plates to an internal side or external side; and
a fixing protrusion extending from the center of the bottom plate toward the upper flange, with upper portions extending in opposite directions.

9. A constructing method of a structural composite hybrid beam comprising an attached fire-resistant coating material, the method comprising:
forming a steel plate into a cold-formed steel plate beam having a form shape including a pair of side plates, a bottom plate, and upper flanges;
adhering at least one flow preventing member comprising an attach plate and a support plate to a side of the side plate;
mixing and stirring the fire-resistant coating material with water in a ratio of from 1:1 to 1:1.3 sufficiently for about 3 to about 5 minutes;
spraying the stirred fire-resistant coating material by using an ejecting nozzle, while maintaining a distance between a coated surface of the structural composite hybrid beam and the ejecting nozzle to be from about 30 cm to about 60 cm, the pressure of a compressor to be from about 2.5 kg/cm² to about 5 kg/cm², and an air amount to be about 0.4 m³/min to about 0.5 m³/min; and
curing the sprayed fire-resistant coating material.
